(19) United States
(12) Patent Application Publication
(10) Pub. No.: US 2001/0013183 A1
(43) Pub. Date: Aug. 16, 2001

(54) Memorial markers

(76) Inventors: Keith Yager, Tulsa, OK (US); James Culver, Tulsa, OK (US); Monte England, Tulsa, OK (US)

Correspondence Address: HEAD JOHNSON & KACHIGIAN, 228 W 17TH PLACE, TULSA, OK, 74119, US

(21) Appl. No.: 09/769,190

(22) Filed: Jan. 24, 2001

Related U.S. Application Data
(63) Continuation-in-part of application No. 09/425,127, filed on Oct. 22, 1999.

(51) Int. Cl. G09F 19/00

(52) U.S. Cl. 40/124.5

(57) ABSTRACT

A modular memorial marker for marking a gravesite. The marker is created from a top shell having a top and a plurality of sides and a bottom shell which create a cavity into which a filler material is inserted to provide support for the top surface. Selected external elements, such as nameplates and decorative elements, are secured to the top surface of the marker. Selected internal elements, such as storage compartments and bolt receiving slugs, are provided under the top surface in the filler material or metal frame. The marker may be mounted on a slab and the entire unit is installed at the gravesite.

### REFERENCE TO PENDING APPLICATIONS

This application is a continuation-in-part of co-pending U.S. patent application Ser. No. 09/425,127, filed Oct. 22, 1999, and entitled MEMORIAL MARKERS AND METHOD FOR PRODUCING THE SAME.

### BACKGROUND OF THE INVENTION

1. Field of the Invention

The present invention relates to a novel memorial marker for use at a gravesite in a cemetery which will be inexpensive to produce, will withstand the elements and other factors, and is modular in design.

2. Prior Art

Currently available memorial markers are generally of two basic types, i.e., a marker entirely of granite, marble or concrete, or alternately, a marker of cast metal, such as bronze, that is made by a casting process such as traditional sand casting. Both types of markers are expensive, because the process of manufacturing them is labor intensive. In addition, both types of markers can only be made at a limited number of manufacturing facilities, which causes transportation costs to be added to the cost of the marker and increases the time required to place a marker set at a gravesite. Both types of markers are subject to considerable wear and tear in a cemetery. They are also difficult or impossible to repair when they are damaged, such as when the marker is struck by a lawn mower or run over by a vehicle. Consequently, these types of markers are expensive to maintain, and markers often must be replaced when they are damaged and cannot be repaired. A damaged marker may remain at a gravesite for a long time if the family of the deceased person for whom a marker was purchased cannot afford to replace the marker promptly.

The present invention addresses these shortcomings by providing a new type of marker that is esthetically pleasing and is durable. This new marker is similar to cast bronze memorial markers in appearance, and it can withstand the elements as well as or better than currently available memorial markers. The present invention is constructed with less expensive materials and by a method that is less labor intensive, which greatly reduces the cost of markers to the consumer.

The use of modular elements in the present invention makes it possible for a local funeral home or cemetarian to repair a marker from the modular elements, thus reducing the time required to repair a marker at a gravesite and making repairs to the marker cheaper and easier. Finally, the memorial marker of the present invention offers features not presently available in currently available markers, such as a sealed and locked compartment in the marker for storage of compact computer disks containing information relating to the deceased person or mementos of the deceased person.

### SUMMARY OF THE INVENTION

The present invention is a new type of memorial marker for use in marking the gravesite of a deceased person. The memorial marker consists of a top shell having a surface and a plurality of sides and a bottom shell made of bronze sheet metal. A block of preformed filler material, such as compressed polyurethane, is inserted into the shells. The filler material provides mechanical support for the top shell. Compressed polyurethane is available in a variety of densities and may be cut to the appropriate size using a milling machine.

The top surface of the memorial marker is normally formed so that it is either leather looking or smooth. Various external elements may be secured to the top surface of the memorial marker by fasteners. These external elements may include the family name of the deceased person, the first and middle name or initial of the deceased person, the dates of birth and death for the deceased person, and decorative edging for the marker. The external elements may be formed from bronze sheet metal, cast bronze, or other materials. Fastener receiving holes may be made in the external elements and the surface of the top shell either when the external elements and top surface are formed or afterwards.

The filler material will generally contain resealable compartments for holding memorabilia or remote locating devices A resealable compartment will normally be covered by a rigidly attached lid on the side surface of the marker.

The bottom shell and the filler material will also generally contain bolt receiving slugs or holes into which bolts may be inserted in order to secure shells and the filler material to a slab made of granite, marble, preformed concrete or a similar material. Bolt openings that are aligned with the threaded bolt receiving slugs or holes are drilled through the slab, and then bolts are inserted through large washers and the bottom of the slab. Next, the bolts are threaded into the threaded bolt-receiving slugs or holes and then tightened until the marker is firmly secured to the slab.

The memorial marker will also generally contain a round opening for a vase to hold flowers. The round opening for the vase will extend through the top shell surface, through the filler material, through the bottom shell and through the slab.

If the slab is of concrete, it is installed at the gravesite by placing it directly on the ground. If the slab is of granite or marble, cement is generally added to a hole underneath where the slab is to be placed in order to provide the slab with mechanical support.

### BRIEF DESCRIPTION OF THE DRAWINGS

FIG. 1 is a perspective view of a memorial marker constructed in accordance with one embodiment of the present invention.

FIG. 2 is a top view of the memorial marker shown in FIG. 1.

FIG. 3 is a side view of the memorial marker shown in FIG. 1 illustrating a cover on an interior compartment.

### DETAILED DESCRIPTION OF THE PREFERRED EMBODIMENT

The embodiments discussed herein are merely illustrative of specific manners in which to make and use the invention and are not to be interpreted as limiting the scope of the instant invention.

While the invention has been described with a certain degree of particularity, it is to be noted that many modifications may be made in the details of the invention's construction and the arrangement of its components without departing from the spirit and scope of this disclosure. It is understood that the invention is not limited to the embodiments set forth herein for purposes of exemplification.

Like numbers in the drawings indicate like parts in various embodiments of the invention.

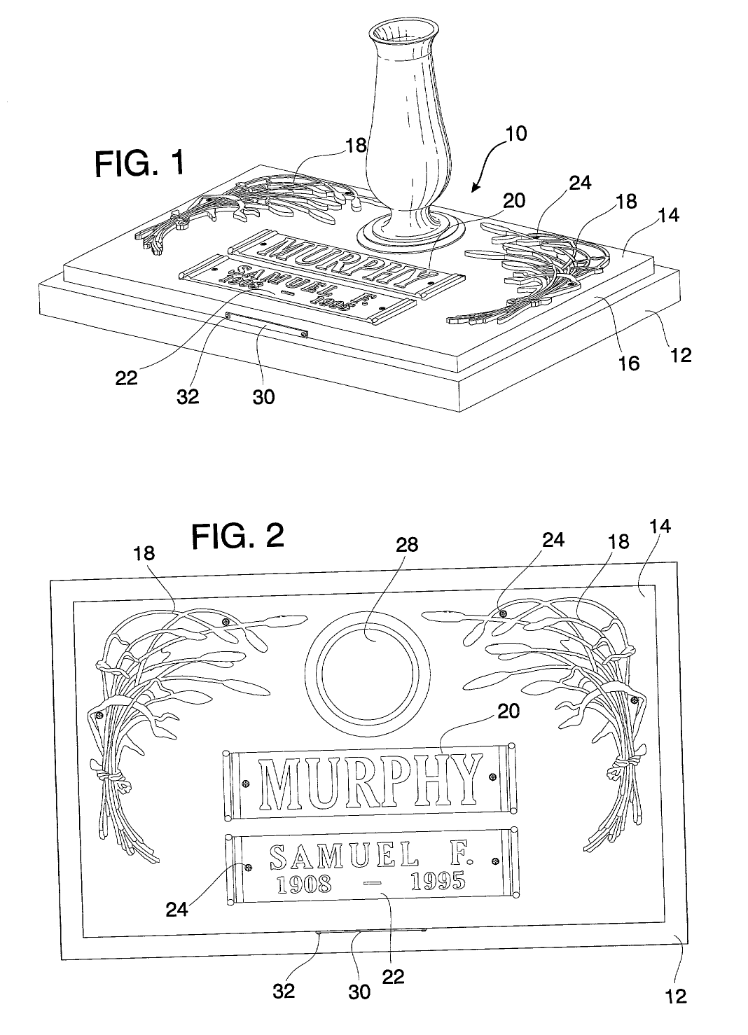

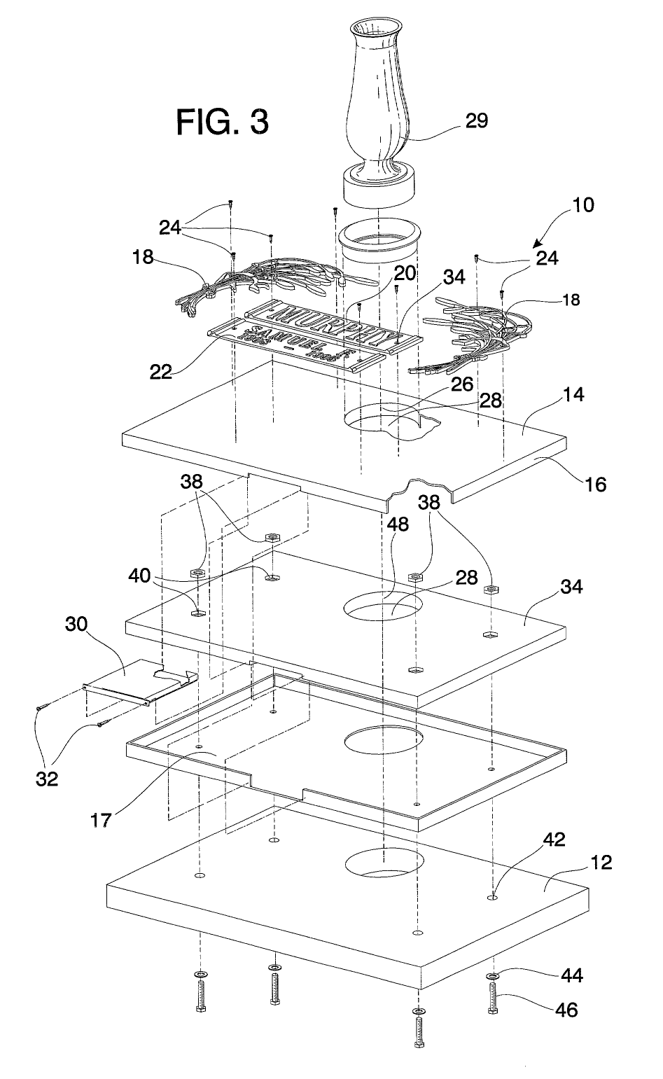

Referring to the drawings in detail, FIG. 1 is a perspective view, FIG. 2 is a top view and FIG. 3 is a side view of a memorial marker for use in marking the gravesite of a deceased person that is constructed in accordance with one embodiment of the present invention. The memorial marker 10 is comprised of bronze sheet metal that is fashioned into a top shell 14 with a surface and a plurality of sides 16, and a bottom shell 17. The marker 10 will be attached to a standard slab 12 made of granite, marble, preformed concrete or a similar material. The slab 12 extends approximately 2 inches on each edge of the marker in accordance with industry standards. Although the marker 10 can be formed into a variety of shapes, a rectangular shape is generally preferred by consumers, as illustrated in the rectangular shaped marker 10 that is illustrated in FIG. 1. The top surface is typically either an embossed leather-looking surface or is smooth.

Various types of external elements 18, 20 and 22 may be removably attached to the top surface 14 of the memorial marker 10 by a plurality of screws 24. These external elements may include an external element 18 that is a decorative design, an external element 20 that bears the family name of the deceased person, and an external element 22 that bears the first name, middle name or initial, or a nickname for the deceased person, and years of birth and death for the deceased person. The type and number of external elements utilized may vary from one style of memorial marker to another. The external elements may be fashioned from bronze sheet metal as well as from cast bronze or other materials.

The memorial marker may also be provided with a round vase opening 28 for admitting a vase 29 for holding flowers. When the vase is not in use for holding flowers, it may be inverted and placed in the vase opening so that the bottom of the vase is flush with the top surface 14 of the marker.

An additional external element 30 is a case for an internal compartment and may be attached to a side surface 16 of the memorial marker by fasteners 32 to removably secure the case to the shell. The resealable compartment may be used to store various items, such as a computer compact disk, mementos of the deceased person, or a transponder for use in locating the grave-site. To insure that the resealable compartment remains dry inside, a gasket may be provided at the mouth of the resealable compartment so that the gasket is held in place between the mouth of the resealable compartment and the rigidly attached lid when the lid is attached to the resealable compartment. Although the invention has been described as having a resealable compartment, the invention is not so limited and there may be more than one compartment, and the compartments may be permanently sealed. However, a resealable compartment is preferred since it can be opened to access the items in the compartment.

In order to attach the shells 14 and 17, and the filler material 34 to the slab 12, a plurality of holes 40 are made through the bottom shell 17 and the filler material so that a plurality of threaded bolt receiving nuts 38, which are aligned with the holes in the filler material, and holes made through the slab 12 onto which the memorial marker is to be attached. A plurality of bolts 46 are first inserted through large washers 44, then inserted through the bolt openings, and finally are inserted into the threaded bolt-receiving nuts 38. The bolts 46 are then tightened by turning them until the memorial marker is firmly secured to the slab 12.

The vase opening 28 extends through the top shell 14, through the filler material 34, through the bottom shell 17 and the slab 12 so that the vase 29 can be stored in an inverted position when it is not being used to hold flowers. In FIGS. 1 and 3, the vase 29 is shown in an upright position for use. When the memorial marker 10 is installed at a gravesite, it is desirable to place a layer of gravel under the slab 12 to facilitate drainage through the vase opening.

Once the marker 10 is securcd to the slab 12, the memorial marker 10 or 12 is ready to be installed at the gravesite. If the slab is made of granite or marble, cement is generally added to a hole underneath where the slab is to be placed in order that the slab will be sufficiently supported. If the slab is made of concrete, the addition of a cement pad underneath the slab is not necessary and the concrete slab can be placed directly on the ground at the desired location.

In the event that the top shell is hit by a lawn mower, the dense filler material provides an opposing force to prevent the thin top shell from being dented. In the event, however, that the top shell is dented or otherwise damaged, it may be easily and inexpensively replaced.

The present invention has been described in relation to the drawings attached hereto. It should be understood that other modifications besides those shown or suggested above may be made within the spirit and scope of this invention.

What is claimed is:

1. A memorial marker, which is securable to a slab, for marking a gravesite comprising:
a top shell made of bronze and a bottom shell made of bronze to form a cavity,
a filler material to fill said cavity and provide support for said top shell, and
a plurality of external elements that are removably secured to said top shell.

2. A memorial marker according to claim 1, wherein said external bronze elements comprise:
at least one name plaque.

3. A memorial marker according to claims 1 or 2, wherein said external bronze elements comprise:
at least one date plaque.

4. A memorial marker according to claim 1, wherein said external bronze elements comprise:
at least one decorative plaque.

5. A memorial marker according to claim 1, including an opening through said top shell, through said bottom shell and through said filler to form a vase sleeve with an associated removable vase.

6. A memorial marker according to claim 1, wherein said external bronze elements are attached to said base by fasteners through screw holes provided in said external bronze elements.

7. A memorial marker according to claims 1 or 2, wherein said external elements are created by forming sheets of bronze into the desired configurations.

8. A memorial marker according to claims 1 or 2, wherein internal elements are provided below said top surface.

9. A memorial marker according to claim 8, wherein said internal elements comprise:
at least one compartment.

10. A memorial marker according to claim 9, wherein said compartment is resealable.

11. A memorial marker according to claim 8, wherein said internal elements comprise:
at least one bolt receiving slug for receiving a bolt in order to secure said memorial marker to aslab.

12. A method of making a memorial marker for marking a grave site comprising the following steps:
a. forming a bronze sheet into a top shell having a top surface and a plurality of sides and a bottom shell in order to create a cavity,
b. inserting a preformed filler material into said cavity,
c. securing external elements to said top surface, and
e. attaching said top shell, said bottom shell, said filler material and external elements to a slab.

13. A method of making a memorial marker as set forth in claim 12 wherein said preformed filler material is a dense polyurethane.

14. A method of making a memorial marker as set forth in claim 12 wherein said external elements are secured by removable fasteners.
